(19) United States
(12) Patent Application Publication
(10) Pub. No.: US 2014/0327443 A1
(43) Pub. Date: Nov. 6, 2014

(54) OBJECT DETECTION SYSTEM AND METHODOLOGY

(71) Applicant: SCHLUMBERGER TECHNOLOGY CORPORATION, Sugar Land, TX (US)

(72) Inventors: Zhanke Liu, Sugar Land, TX (US); Shunfeng Zheng, Katy, TX (US); Mirjam Zwanenburg, Amsterdam (NL)

(21) Appl. No.: 14/335,031

(22) Filed: Jul. 18, 2014

Related U.S. Application Data
(63) Continuation-in-part of application No. PCT/US2013/052230, filed on Jul. 26, 2013.
(60) Provisional application No. 61/676,814, filed on Jul. 27, 2012.

(51) Int. Cl. G01V 3/08

(52) U.S. Cl. CPC G01V 3/081
USPC 324/326

(57) ABSTRACT

A technique facilitates detection of an object passing along a conduit, such as a wellbore conduit. The object is released into an internal passage of the conduit, and the conduit is monitored at a given location or locations along the conduit. Movement of the object past the location or locations is detected by a sensor, such as a sensor positioned externally with respect to the internal passage of the conduit. Passage of the object is monitored via detection of a unique electro-magnetic signature as the object moves along the interior of the conduit and past the location.

### CROSS-REFERENCE TO RELATED APPLICATIONS

The present document is a continuation-in-part application claiming priority under 35 U.S.C. §120 to PCT Application Serial No. PCT/US2013/052230 filed on Jul. 26, 2013 and entitled “Object Detection System and Methodology”, which was based on and claimed priority to U.S. Provisional Application Ser. No. 61/676,814, filed Jul. 27, 2012, the entire disclosures of which are hereby incorporated by reference in their entireties.

### BACKGROUND

When performing oilfield services, e.g. well interventions, well services, completion related services, or wireline services, dropped objects may be used to perform a desired operation or operations. For example, a steel ball or a metal dart may be dropped and/or pushed through a conduit, such as coiled tubing or treating irons, to activate perforating guns, to open a downhole valve, to disconnect a downhole tool, or to perform other operations. Due to the non-transparent nature of well conduits, the steel ball or metal dart typically is invisible from outside the conduit. The steel ball or metal dart does not tend to generate sufficient acoustic and/or vibration signals for such objects to be detected during launching and/or passing of specific conduit locations. Additionally, sometimes the ball can move so fast that there is no pressure indication of the ball being seated and thus no indication that the ball or object actually went down hole. This can cause doubt during the ball drop operation as to whether the operation went as intended. Certain systems have been designed to detect passage of a bottom hole assembly, but such systems are not able to detect passage of balls or other objects through tubing.

### SUMMARY

In general, a methodology and system are provided for detecting an object passing along an interior passage of a conduit, such as a wellbore conduit. The object is released into the conduit, and the conduit is monitored at a given location or locations along the conduit. Movement of the object past the location or locations is detected by a sensor, e.g. a sensor positioned externally with respect to the interior passage of the conduit. Passage of the object is monitored via detection of a unique electro-magnetic signature as the object moves along the interior passage and past the location.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of a conduit system, e.g. a coiled tubing system, having a sensor, according to an embodiment of the disclosure;

FIG. 2 is a schematic illustration of an example of a conduit system, e.g. a wellbore conduit system, having a plurality of external sensors, according to an embodiment of the disclosure;

FIG. 3 is a schematic illustration of an example of a processing system that may be used in cooperation with the external sensor or sensors, according to an embodiment of the disclosure;

FIG. 4 is a graphical illustration of data plotted to show detection of a unique electro-magnetic signature, e.g. a magnetic flux leakage signature, as an object passes along an interior of a conduit, according to an embodiment of the disclosure; and

FIG. 5 is a schematic illustration of an example of a sensor system which may be employed in the overall conduit system, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a methodology and system to detect an object as that object moves along an interior passage of a conduit, such as a wellbore conduit. In some applications, the object may be a released ball or dart which moves through coiled tubing or another type of wellbore conduit. The object is released into the conduit, and the conduit is monitored at a given location or locations along the conduit. As the object moves past the location or locations, the object is detected by a sensor, such as a sensor positioned externally with respect to the interior passage of the conduit. Passage of the object is monitored via detection of a unique electro-magnetic signature, e.g. changes in magnetic flux leakage, as the object moves along the interior passage and past a location, e.g. past the sensor. Within this document, “conduit” may represent a variety of conduit types. In well applications, for example, conduit may include “coiled tubing” and “wellbore tubing” which may be used interchangeably to define an oilfield tubing string that has an internal bore to allow movement of materials (fluid, gas, and/or solids) through the internal bore. The conduit can be a fixed installation (not moving) in the wellbore, or it can move relative to the wellbore during an operation.

In some embodiments, the system is designed to output data which provides a timely and accurate record of the passing of objects through locations of interest along the conduit. The sensors may comprise a variety of sensors able to detect a unique, electro-magnetic signature which effectively make the objects visible to the sensor. For example, some sensors are designed to detect the electro-magnetic signature by detecting changes in magnetic flux leakage as the object passes the sensor. One embodiment of such a sensor is a Hall effect sensor able to detect a magnetic field. The sensor systems generally comprise a component that generates an electro-magnetic signature, e.g. a magnetic field, and another component that detects the electro-magnetic signature, e.g. the magnetic field. A variety of magnetic sensors and other types of sensors may be employed to detect the unique, electro-magnetic signature of the passing object. In some applications, the passing object may contain the sensor for detecting the unique electro-magnetic signature, e.g. magnetic field, generated at a location external to the conduit. The sensor systems may be designed to detect a variety of object sizes and to differentiate between objects of different sizes and/or different configurations.

In a variety of applications, the system and methodology employ wellbore conduits which are disposed along vertical and/or deviated wellbores. Objects are released downhole to perform desired functions, e.g. activating perforating guns, actuating downhole valves, disconnecting downhole tools, and/or a variety of other downhole operations. The object may be in the form of a ball, dart, or other suitable object which is released into the wellbore conduit, e.g. coiled tubing, production tubing, or other types of wellbore metallic or non-metallic conduits. In these applications, the object is a metallic object in that it contains metal able to induce the unique, electro-magnetic signature detectable by the sensor or sensors placed along the exterior of the wellbore conduit. In some applications, the objects may be formed of other types of materials able to provide a suitable electro-magnetic signature detectable by the sensor or sensors.

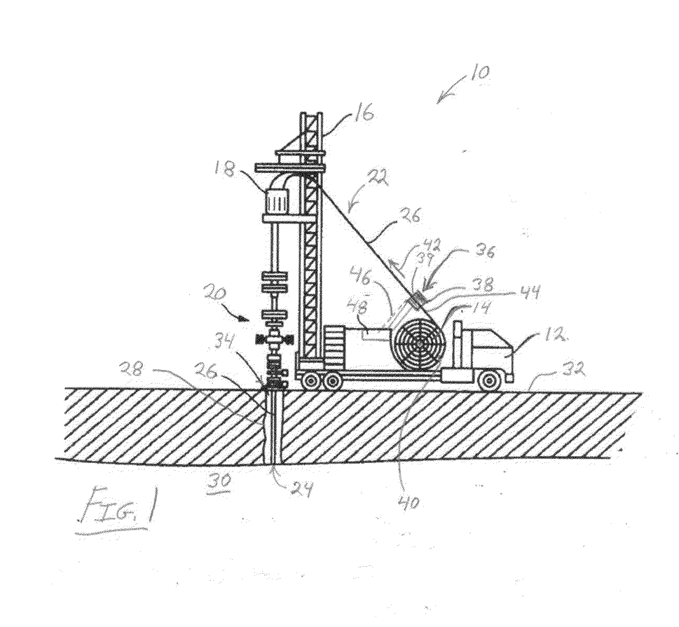

Referring generally to FIG. 1, an embodiment of a system 10 is illustrated although many other embodiments of system 10 may be used depending on the specific application. In the embodiment illustrated, system 10 comprises a coiled tubing truck 12 having a coiled tubing reel 14 which cooperate with a mobile rig 16. The mobile rig 16 may have a goose neck injector 18 which operates in cooperation with pressure control equipment 20. In this example, a conduit 22, e.g. coiled tubing, is run from coiled tubing reel 14 to the goose neck injector 18 supported by mobile rig 16 and then is advanced down through pressure control equipment 20. As described in greater detail below, the conduit 22 has an internal passage 24. It should be noted that depending on the application conduit 22 may comprise a variety of types of conduits, including metal conduits, non-metal conduits, conduits having circular cross-sections, conduits having noncircular cross-sections, and other types of conduits. In many applications, conduit 22 comprises a wellbore conduit, such as a wellbore tubing 26 in the form of, for example, coiled tubing, production tubing, and/or other types of well related tubing. Referring to the specific example illustrated in FIG. 1, wellbore tubing 26 is in the form of coiled tubing.

In the example illustrated, conduit 22/coiled tubing 26 is deployed in a wellbore 28 which extends to a subterranean region 30, such as a subterranean formation. The wellbore 28 extends to the subterranean region 30 from a surface location 32. In some applications, the conduit 22/coiled tubing 26 extends from a wellhead 34 or other structure located at surface 32. Depending on the application, surface location 32 may be an earth surface or a subsea surface, e.g. a seabed.

Referring again to FIG. 1, system 10 further comprises a sensor system 36 having at least one sensor 38 and at least one magnetic field component 39, e.g. a permanent magnet or an electromagnetic coil. In this example, the sensor 38 and the magnetic field component 39 are mounted externally of internal passage 24 and are designed to detect movement of an object 40 past sensor 38 as that object 40 travels along internal passage 24 (indicated by arrow 42) and interrupts the magnetic field created by magnetic field component 39. By way of example, magnetic field component 39, e.g. permanent magnet or electromagnetic coil, may be mounted in proximity with sensor 38. In another embodiment, however, the magnetic field component 39 can be formed as part of object 40 for movement past sensor 38. In either embodiment, sensor 38 may be positioned, e.g. mounted, along an exterior of conduit 22. For example, sensor 38 may be mounted or otherwise positioned along an exterior surface 44 of coiled tubing 26 in a manner which enables movement of the coiled tubing 26 through the sensor 38 as the coiled tubing is deployed into wellbore 28.

The sensor system 36 further comprises a communication line 46 which communicates data from sensor 38 to a processing system 48. Communication line 46 may be in the form of a hard wired or wireless communication line. For example, communication line 46 may comprise a conductor or conductors routed along an exterior surface of the conduit, within the internal passage of the conduit, or through the wall of the conduit 22. In other applications, communication line 46 may be a wireless communication line and sensor system 36 may comprise appropriate components for sending wireless signals, e.g. pressure pulses, electromagnetic signals, or other suitable signals. In some applications, communication line 46 also may be used to carry signals from processing system 48 to the at least one sensor 38 to enable control over operation of the sensor 38. In this latter example, sensor 38 may be an intelligent sensor which enables selective powering of the sensor, adjusting of sensing parameters, and/or selecting other sensor adjustments.

In the example illustrated, sensor 38 is designed to detect a unique electro-magnetic signature as object 40 passes the sensor 38 along internal passage 24. For example, sensor 38 may comprise a magnetic sensor and object 40 may comprise a suitable metal or other magnetic material which provides the unique electro-magnetic signature detected by sensor 38 as object 40 passes magnetic field component 39, e.g. a permanent magnet or an electromagnetic coil. In some applications, sensor 38 is a magnetic flux leakage detection sensor which detects the unique electro-magnetic signature in the form of changes to the magnetic flux leakage as object 40 moves past the sensor 38. A specific example of a suitable sensor 38 is a magnetic sensor, such as a Hall effect sensor. However, a variety of other magnetic sensors and other types of sensors may be employed to detect the unique electro-magnetic signature of the passing object 40. The unique electro-magnetic signature may vary according to the structure, size, material composition, and/or other parameters of object 40. Accordingly, the sensor 38 may be used to detect an electro-magnetic signature which uniquely corresponds to specific types of objects 40 passing along internal passage 24. Generally, the sensor system 36 is designed to generate an electro-magnetic signature, e.g. magnetic field, and to detect the electro-magnetic signature, e.g. electromagnetic field. In some applications, the magnetic field is generated by the object 40 and detected by sensor 38 located externally of internal passage 24. In other applications, the sensor 38 can be located on object 40 for detection of an electro-magnetic signature, e.g. magnetic field, generated at a specific location externally of the internal passage 24.

The object 40 may be constructed in several forms and from a variety of materials, including composite materials. For example, object 40 may be in the form of a ball, a dart, or another suitable form designed to move freely along internal passage 24. The illustrated object 40 is representative of such balls, darts, or other suitable constructions. When magnetic sensors 38 are employed, the object 40 may be formed of a metal material or a composite material containing metal. For example, object 40 may be a steel ball or a metal dart. However, object 40 also may carry the magnetic field component 39 which may be in the form of, for example, a permanent magnet. This latter approach allows the object 40 to be made from many types of materials. In a first scenario, for example, the object 40 does not contain an active magnetic source (i.e. does not contain magnetic field component 39) and the detection relies on a passive magnet source, e.g. magnetic field component 39 clamped or otherwise mounted along conduit 22. In this embodiment, the object 40 comprises a ferromagnetic material, such as iron, nickel, cobalt, or other suitable ferromagnetic material. In a second scenario, object 40 may be designed to include magnetic field component 39 such that the object 40 becomes an active magnet source. In this latter example, the object 40 can be constructed from other types of materials, e.g. non-ferromagnetic materials, and the unique electro-magnetic signature is still detectable by sensor 38 as the object 40 moves past sensor 38. If object 40 includes magnetic field component 39, the object 40 may be formed from many types of metallic and nonmetallic materials, including aluminum, copper, composites, and/or other suitable materials.

During an operation, object 40 is released into conduit 22, e.g. coiled tubing 26, to perform a desired operation or operations, e.g. activating perforating guns, opening or closing a downhole valve, disconnecting a downhole tool, and/or performing other suitable operations. In such well related applications, the object or objects 40 may be released and moved through conduit 22 for a variety of well intervention applications, well service applications, completion applications, wireline applications, and/or other well related applications. The object 40 may be pumped along internal passage 24 once the object 40 is released into the conduit 22, e.g. coiled tubing 26. In other applications, however, the object 40 also may be dropped and moved via gravity or otherwise pushed along internal passage 24 to the desired mechanism actuated by object 40. The sensor or sensors 38 provide a timely and accurate indication of the passing of each object 40 through the selected location monitored by the corresponding sensor 38. The sensor data regarding passage of object 40 is then relayed to processing system 48.

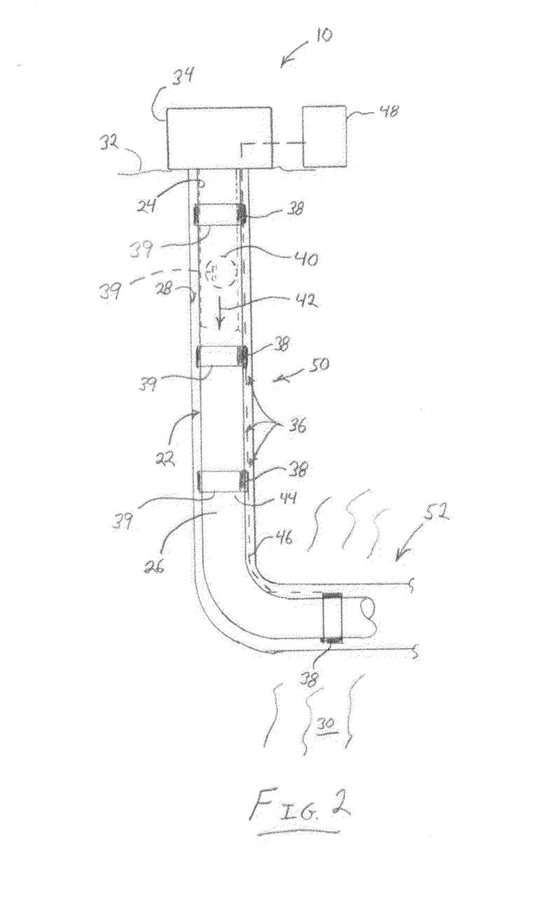

Referring generally to FIG. 2, another embodiment of system 10 is illustrated. In this example, system 10 comprises sensor system 36 with a plurality of the sensors 38 located externally with respect to internal passage 24. The plurality of sensors 38 can be located above the surface 32, but the sensors 38 also can be located along wellbore 28 or with sensors both above and below surface 32. In the example illustrated, the plurality of sensors 38 is mounted along the exterior of conduit 22 extending down into wellbore 28. Sometimes, individual sensors or the plurality of sensors 38 can be incorporated into the conduit 22 at a location external to internal passage 24. As illustrated, the magnetic field component 39 can be mounted along conduit 22 or it can be formed as part of object 40. In either case, movement of the object 40 past sensor 38 creates the unique, electro-magnetic signature detectable by sensor 38.

In wellbore applications, the plurality of sensors 38 may be positioned along wellbore tubing 26. By way of example, the sensors 38 may comprise magnetic sensors as described above for detecting the unique electro-magnetic signature caused by passage of each object 40. By placing the sensors 38 along the conduit 22, e.g. wellbore tubing 26, at specific locations, the movement of each object 40 along internal passage 24 may be tracked. Each sensor 38 provides a timely and accurate indication of the passing of each object 40 via the electro-magnetic signature, and this data is relayed via communication line(s) 46 to processing system 48. As illustrated, the sensors 38 may be placed along a vertical wellbore section 50 and/or a horizontal wellbore section 52. Some well systems may utilize a plurality of vertical wellbore sections 50 and/or horizontal wellbore sections 52.

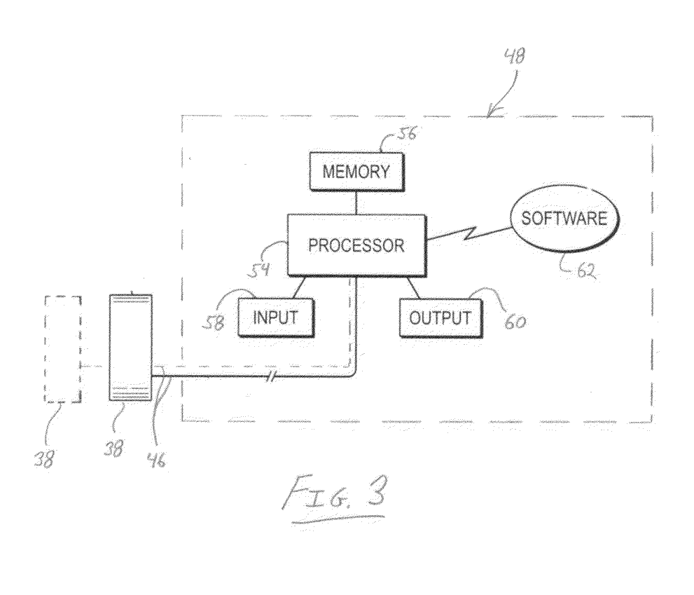

Depending on the specific application, processing system 48 may have a variety of features and configurations. For example, the processing system 48 may be located at a surface location 32, within wellbore 28, partially within the wellbore 28 and at surface location 32, and/or at other suitable locations. Referring generally to FIG. 3, an example of processing system 48 is illustrated. In this example, processing system 26 is in the form of a computer-based system having a processor 54, such as a central processing unit (CPU). The processor 54 is coupled with sensor or sensors 38 via communication line 46 and is operatively employed to intake sensor data on the unique electro-magnetic signatures caused by passing objects 40. Processing system 48 is then able to process that data as desired, e.g. according to a suitable program, algorithm, model, or other appropriate software. For example, the processor 54 may be used to compare data obtained by sensors 38 with a predetermined signature caused by passage of a specific type of object 40, e.g. ball or dart.

The processor 54 also may be operatively coupled with a memory 56, an input device 58, and an output device 60. In some applications, processor 54 is used to run software 62, such as signature matching software which compares data obtained from sensors 38 with data characteristics of the predetermined electro-magnetic signature associated with passage of each object 40. Software 62 may comprise models, algorithms, programs, and/or a variety of other suitable software depending on the types of sensors 38 employed, types of signatures evaluated, the environments in which system 20 is employed, and/or other operational parameters.

By way of example, input device 58 may comprise a variety of devices, such as a keyboard, mouse, voice recognition unit, touchscreen, other input devices, or combinations of such devices. Output device 60 may comprise a visual and/or audio output device, such as a computer display, monitor, or other display medium having a graphical user interface. Additionally, the processing may be performed on a single device or multiple devices on location, away from the sensing location, or with some devices disposed on location and other devices located remotely. The software 62 (in the form of a suitable algorithm, model, or other programming) may be used to evaluate data from sensors 38 in real time to provide real-time indications of the position of object 40 along the internal passage 24 of conduit 22. Processing system 48 also may be employed to evaluate historical electro-magnetic signatures and/or other data stored in memory 56 or at another suitable storage location.

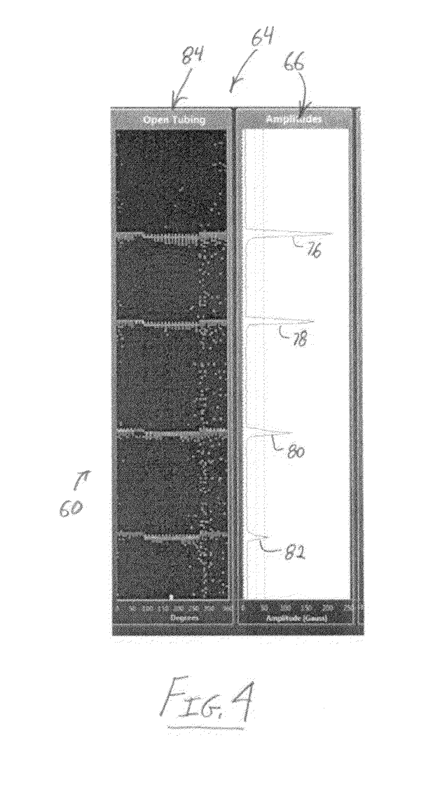

In some applications, processing system 48 and output device 60 may be used to indicate movement of objects 40 past specific sensors 38 (as well as a variety of other possible data) via a graphical user interface 64, as illustrated in FIG. 4. The raw and/or processed data displayed via graphical user interface 64 may vary substantially depending on the parameters of a given application. For example, sensors 38 and processing system 48 may be designed to output data on parameters, such as amplitude 66. However, the graphical user interface 64 may have a variety of forms and configurations for displaying many types of data from individual or multiple sensors 38.

In the specific example of FIG. 4, the graphical user interface 64 illustrates data output by a specific sensor 38. Data from the sensor 38 has been processed and output to provide a visual indicator of the unique, electro-magnetic signature associated with the passing of graduating size steel balls 40 through conduit 22. For example, the amplitude section 66 of graphical user interface 64 illustrates four peaks 76, 78, 80, and 82 of varying size which correspond to steel balls 40 of varying diameter passing the specific sensor 38. Basically, a larger diameter of the object/ball 40 causes a higher amplitude of the corresponding peak. In this example, the graphical user interface 64 further comprises an open tubing plot 84, and the electro-magnetic signature resulting from the object 40 passing sensor 38 is illustrated as spanning the internal passage 24 (360° circumferentially). This open tubing plot 84 increases the detectability of the object 40 passing in real-time during an actual field job.

Detection of the passing object 40 also may be used to generate outputs on graphical user interface 64 that provide additional information about the object 40. As described above, the electro-magnetic signatures captured by processing system 48 and software 62 may be used to detect the real time passing of balls or other objects 40 and the amplitude of those signatures can be used as an indicator of the size of the passing object 40. However, the sensor system 36 also may be employed to detect and differentiate ball types, balls of different sizes, objects of different configurations, and/or other unique parameters of the objects 40 based on the unique electro-magnetic signature provided by the specific objects 40.

It should be noted that use of the sensor or sensors 38 and overall system 20 is not limited to the detection of steel balls but may be used to detect a variety of other types of objects 40 made of a variety of materials including metal objects, composite objects, or other objects capable of providing an electro-magnetic signature. The objects 40 also may be detected regardless of the direction of movement past each sensor 38. In a wellbore application, for example, movement of the object 40 may be detected in different directions during either pumping down or flow back. Furthermore, many types of conduits 22 may be utilized in many types of applications. For example, conduit 22 may comprise tubing in the form of coiled tubing, treating irons, pipe lines, metal pipes, non-metal pipes, and/or a variety of other types of conduits to which the sensors 38, e.g. magnetic sensors, are mounted externally of the internal passageway 24. In many applications, conduit 22 is stationary during movement of objects 40 along the internal passage 24. However, some applications may utilize sensors 38 to detect movement of internal objects 40 while the conduit 22 is in motion, e.g. while coiled tubing is deployed through the sensor or sensors 38.

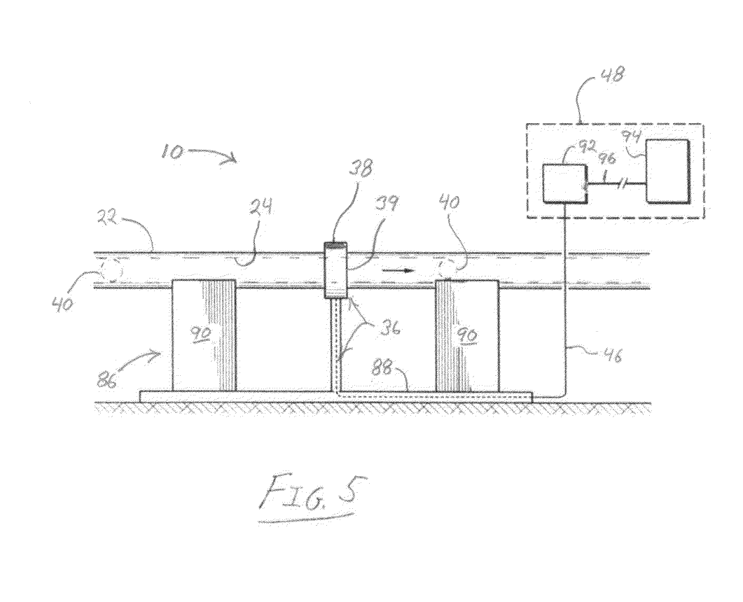

Referring generally to FIG. 5, another embodiment of system 10 is illustrated. In this embodiment, conduit 22 is not necessarily disposed within wellbore 28. Again, sensors 38 may comprise a variety of sensors, such as magnetic sensors, however one example of a suitable sensor comprises a pipe integrity device, such as a coiled tubing pipe integrity device. In the example illustrated, sensor 38 and magnetic field component 39 are again positioned externally of internal passage 24 and may be mounted external to conduit 22. However, magnetic field component 39 could be part of object 40, as described above. In the embodiment illustrated, conduit 22 may be mounted on a fixture 86 which may comprise a base stand 88 and a mounting structure 90 designed to support conduit 22 on base stand 88. In some applications, fixture 86 may secure conduit 22 in a stationary position and in other applications fixture 86 may be designed to enable movement of conduit 22, e.g. movement of wellbore tubing/coiled tubing 26 downhole into wellbore 28. In this latter example, conduit 22 and sensors 38 may undergo relative movement with respect to each other during monitoring for passage of objects 40.

In the embodiment illustrated in FIG. 5, sensor 38 may again comprise a variety of types of sensors designed to detect movement of objects 40 along internal passage 24 via changes in the electro-magnetic signature, e.g. changes in the magnetic flux leakage, due to passage of each object 40. As with the embodiments discussed above, sensor system 36 may comprise a single sensor 38 or sensor system 36 may comprise a plurality of sensors 38, e.g. a plurality of magnetic flux leakage detection device probes. If a plurality of sensors 38 is employed, the sensors 38 may be positioned at different locations along conduit 22 and those sensors 38 may be designed to sense the same parameter or different types of parameters. In some applications, the sensor or sensors 38 also may be designed to detect anomalies in conduit 22 as conduit 22 is moved through the sensor or sensors 38.

Data obtained by each sensor 38 is transmitted via communication line(s) 46 to processing system 48. Communication line(s) may again be in the form of a wired or wireless communication line designed to carry signals from each sensor 38 to processing system 48 for evaluation and processing. In some applications, however, the communication line(s) 46 also may be used to carry signals from processing system 48 to the sensor or sensors 38. In this example, processing system 48 may be located proximate mounting fixture 86 or it may be located in whole or in part at a remote location. For example, a first portion or portions 92 of processing system 48 may be located proximate fixture 86 while another portion or portions 94 of the processing system 48 may reside at a remote location. In some applications, the data from the sensor or sensors 38 may be processed at least partially at both the proximate location and the remote location. However, in other applications the first component 92 may be used to transmit data for processing at the remote location on remote processing component 94. These split types of processing systems 48 may be employed with the other embodiments also described herein.

Results obtained via the processing of data from sensors 38 can be displayed or otherwise output to an operator at the proximate and/or remote locations. Communication between the proximate location and the remote location or locations, e.g. between proximate portion 92 and remote portion 94 of processing system 48, may be implemented via a suitable communication system 96. In some applications, the communication system 96 is designed to incorporate the Internet, thus allowing transfer raw data, processed data, analyses, recommendations, instructions, evaluation adjustments, and/or other types of communications between desired locations and between components of the overall system 10.

Additionally, the processing system 48 may reside at one location or at a plurality of locations to process data, and the results may be distributed to two or more locations, e.g. two or more other locations. The sensing system 36 in cooperation with processing system 48 provides an effective way of detecting and recording the passing of objects 40, e.g metallic objects, using electro-magnetic tools. Examples of such electro-magnetic tools comprise sensors 38 in the form of magnetic sensors, e.g Hall effect sensors or other types of magnetic sensors, combinations of sensors, and/or other sensors able to detect the unique electro-magnetic signature, e.g magnetic flux leakage signatures, through a conduit wall.

As described herein, the overall system 10, including sensor system 36 and processing system 48, may be used in a variety of operations, including many types of wellbore related operations. Depending on the specifics of a given application, a variety of sensor systems 36, processing systems 48, software 62, and/or other components may be utilized to monitor the passage of objects 40. In some applications, the system may be designed to indicate the specific type of object 40 passing each sensor 38 along internal passage 24. For example, the system may be designed to indicate objects 40 having different diameters or sizes, different material compositions, different configurations, or other attributes differentiating one object 40 from another.

Additionally, many types of sensors 38 and different numbers of sensors 38 may be employed for a given application. Depending on the specific type of sensors 38/magnetic field components 39 employed in a given system 10, adjustments may be made to the system structure and/or data processing to accommodate the characteristics of the specific sensors 38 and sensor system 36. Similarly, many types/numbers of magnetic field components 39, e.g. permanent magnets or electromagnetic coils, may be employed for the given application.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method for detecting a metal object, comprising:
releasing an object into an internal passage of a conduit;
monitoring at least one location along the conduit; and
detecting movement of the object past the at least one location by a sensor positioned externally of the internal passage, the detection of movement being accomplished via detection of a unique electro-magnetic signature of the object.

2. The method as recited in claim 1, wherein releasing comprises releasing the object into coiled tubing.

3. The method as recited in claim 1, wherein releasing comprises pumping the object along coiled tubing.

4. The method as recited in claim 1, wherein releasing comprises releasing a ball or dart comprising metal.

5. The method as recited in claim 1, wherein releasing comprises releasing the object with a permanent magnet included in the object.

6. The method as recited in claim 1, wherein monitoring comprises monitoring a plurality of locations along the conduit.

7. The method as recited in claim 1, wherein monitoring comprises monitoring a plurality of locations along a wellbore tubing.

8. The method as recited in claim 1, wherein detecting comprises utilizing a permanent magnet or an electromagnetic coil to generate a magnetic field near the sensor.

9. The method as recited in claim 1, wherein detecting comprises utilizing a magnetic flux leakage sensor mounted externally of the conduit to detect changes in magnetic flux leakage as the object moves past the at least one location.

10. The method as recited in claim 1, wherein detecting comprises utilizing a Hall effect sensor to detect the unique electro-magnetic signature as the object moves past the at least one location.

11. A system for detecting passage of an object, comprising:
a conduit having an internal passage;
a magnetic field component; and
an electro-magnetic sensor mounted along an exterior of the conduit, the electro-magnetic sensor being oriented to detect a unique electro-magnetic signature associated with an object moving past the electro-magnetic sensor along the internal passage.

12. The system as recited in claim 11, wherein the magnetic field component comprises a permanent magnet mounted near the electro-magnetic sensor.

13. The system as recited in claim 11, wherein the magnetic field component comprises a permanent magnet as part of the object.

14. The system as recited in claim 11, wherein the conduit is positioned in a wellbore and the electro-magnetic sensor is positioned to detect metallic balls moving along the internal passage.

15. The system as recited in claim 11, wherein the conduit is positioned in a wellbore and the electro-magnetic sensor comprises a plurality of magnetic sensors located along the wellbore.

16. The system as recited in claim 15, wherein the plurality of magnetic sensors detect changes in magnetic flux leakage as the object passes.

17. A method of detecting an object in a wellbore, comprising:
positioning tubing along a wellbore;
releasing an object into the tubing;
moving the object through the tubing;
generating a magnetic field; and
detecting the magnetic field with a sensor as the object moves within the tubing and past the sensor.

18. The method as recited in claim 17, wherein detecting comprises detecting the magnetic field with a plurality of sensors located along the exterior of the tubing.

19. The method as recited in claim 18, wherein detecting comprises using the plurality of sensors to detect changes in magnetic flux leakage upon passage of the object.

20. The method as recited in claim 18, further comprising outputting data from the plurality of sensors to a processing system with respect to objects moving past each sensor.
